(19) United States
(12) Patent Application Publication
(10) Pub. No.: US 2019/0283654 A1
(43) Pub. Date: Sep. 19, 2019

(54) VEHICLE TRANSPORT TIE DOWN SYSTEM

(71) Applicant: GM GLOBAL TECHNOLOGY OPERATIONS LLC, Detroit, MI (US)

(72) Inventor: Kenneth L. Oblizajek, Troy, MI (US)

(21) Appl. No.: 15/921,013

(22) Filed: Mar. 14, 2018

(51) Int. Cl. B60P 7/08

(52) U.S. Cl. CPC B60P 7/0846

(57) ABSTRACT

A method for securing a vehicle to a vehicle transport includes placing a first strap about a portion of a vehicle wheel, the first strap intersecting a circumference of the vehicle wheel, positioning a second strap about another portion of the vehicle wheel, the second strap intersecting a circumference of the vehicle wheel, connecting the first strap to the second strap with a connecting strap, and securing the connecting strap to the vehicle transport.

### INTRODUCTION

The subject disclosure relates to the art of vehicle and, more particularly to a tie down system for transporting vehicles.

After manufacture, vehicles are transported to various parts of the world and offered for sale. Typically, vehicles are transported over land, over rail, or over sea. Regardless of how the vehicle is transported, during transport, the vehicle is secured. In the past, vehicles were tied down to a transport vehicle through frame mounted tie-down mounts. Currently, it has been the practice to strap down vehicle tires to secure the vehicle to the transport vehicle.

To secure the vehicle, a strap is extended about a portion of a circumference of the tire and tightened. When tightened, compressive forces are applied to the tire. The compressive forces may lead to a plastic deformation of the tire. That is, under certain environmental conditions, the tire may take on an undesirable out-of-round condition that is not alleviated when the vehicle is released. The out-of-round condition may lead to premature wear and the promotion of undesirable vehicle vibrations. Accordingly, it is desirable to provide a system for securing vehicles that reduces any likelihood of plastic tire deformations.

### SUMMARY

In one exemplary embodiment, a method for securing a vehicle to a vehicle transport includes placing a first strap about a portion of a vehicle wheel, the first strap intersecting a circumference of the vehicle wheel, positioning a second strap about another portion of the vehicle wheel, the second strap intersecting a circumference of the vehicle wheel, connecting the first strap to the second strap with a connecting strap, and securing the connecting strap to the vehicle transport.

In addition to one or more of the features described herein additional embodiments could include wherein securing the connecting strap to the vehicle transport includes placing the connecting strap in tension.

In addition to one or more of the features described herein additional embodiments could include connecting the first strap to the second strap with another connecting strap.

In addition to one or more of the features described herein additional embodiments could include securing the another connecting strap to the vehicle transport.

In addition to one or more of the features described herein additional embodiments could include wherein securing the another connecting strap includes placing the another connecting strap in tension.

In addition to one or more of the features described herein additional embodiments could include wherein placing the first strap about a portion of the vehicle wheel includes intersecting the circumference at an outer diameter of the vehicle wheel twice.

In addition to one or more of the features described herein additional embodiments could include wherein placing the first strap about a portion of the vehicle wheel includes placing the first strap about the vehicle wheel spaced from a central axis in a first direction and positioning the second strap about another portion of the vehicle wheel includes positioning the second strap about the vehicle wheel spaced from the central axis in a second direction.

In addition to one or more of the features described herein additional embodiments could include wherein placing the first strap about the portion of the vehicle wheel includes connecting a first end of the first strap to a first tensioning device extending about an inner portion of a first side of the vehicle wheel and connecting a second end of the first strap about a second tensioning device extending about an inner portion of a second side of the vehicle wheel.

In addition to one or more of the features described herein additional embodiments could include wherein connecting the first strap to the second strap with the connecting strap includes passing a cable about the inner portion of the first side of the vehicle wheel with the first and second tensioning devices.

In addition to one or more of the features described herein additional embodiments could include wherein securing the connecting strap to the vehicle transport includes fixing a first end of the cable to the vehicle transport and connecting a second end of the cable to a tensioner.

In addition to one or more of the features described herein additional embodiments could include wherein placing the first strap about the portion of the vehicle wheel includes setting a selected length of the first strap through one of a plurality of discrete adjustment positions.

In addition to one or more of the features described herein additional embodiments could include wherein setting the selected length includes engaging a first adjustor mechanism with an opening formed in the first strap.

In addition to one or more of the features described herein additional embodiments could include wherein placing the second strap about the portion of the vehicle wheel includes setting a selected length of the second strap through one of a second plurality of discrete adjustment positions.

In addition to one or more of the features described herein additional embodiments could include wherein setting the selected length includes engaging a second adjustor mechanism with an opening formed in the second strap.

In addition to one or more of the features described herein additional embodiments could include wherein placing the second strap about the portion of the vehicle wheel includes setting a selected length of the second strap through one of a second plurality of discrete adjustment positions.

In addition to one or more of the features described herein additional embodiments could include wherein setting the selected length of the second strap includes engaging a second adjustor mechanism with an opening formed in the second strap.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a vehicle transport having a bed supporting a vehicle secured with a tie down system, in accordance with an exemplary embodiment;

FIG. 2 depicts a side view of a vehicle wheel secured with the tie down system of FIG. 1, in accordance with an exemplary embodiment;

FIG. 3 depicts a front side view of the vehicle wheel of FIG. 2 secured with the tie down system, in accordance with an exemplary embodiment;

FIG. 4 depicts a front view of a vehicle wheel secured with a tie down system, in accordance with an aspect of an exemplary embodiment;

FIG. 5 depicts a detail view of a portion of the tie down system of FIG. 4, in accordance with an aspect of an exemplary embodiment; and

FIG. 6 depicts a portion of the tie down system of FIG. 4, in accordance with an aspect of an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

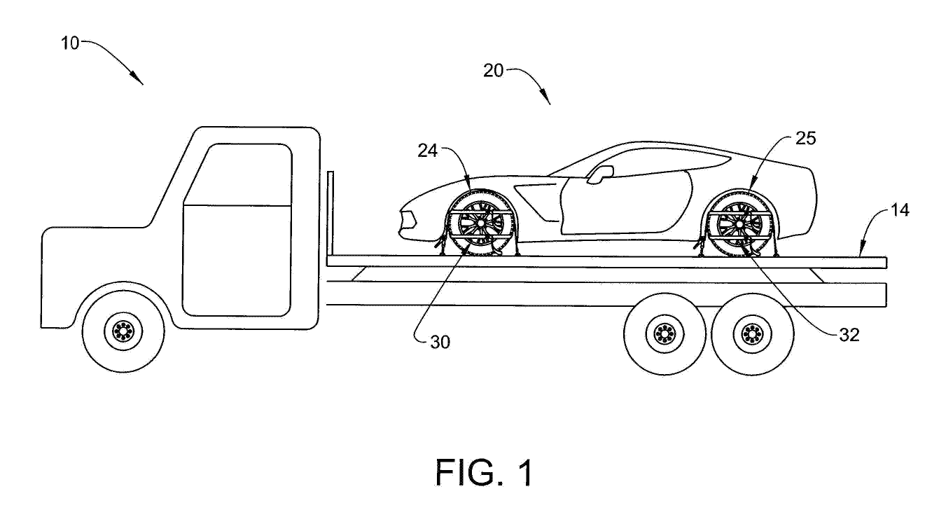

A vehicle transport is indicated generally at 10 in FIG. 1. Vehicle transport 10 includes a vehicle support surface or bed 14 supporting a vehicle 20. Vehicle 20 is shown to include a first wheel 24 and a second wheel 25. Vehicle 20 also includes third and fourth wheels (not shown). It should be understood that the number of wheels may vary and could include more than four. In accordance with an exemplary embodiment, vehicle 20 is secured to vehicle support surface 14 with a first tie down system 30 associated with first wheel 24 and a second tie down system 32 associated with second wheel 25. Additional tie down systems (not shown) may be associated with the third and fourth wheels. At this point it should be understood that vehicle transport 10 may take on a variety of forms including car carriers, rail cars, ships, trailers, and the like.

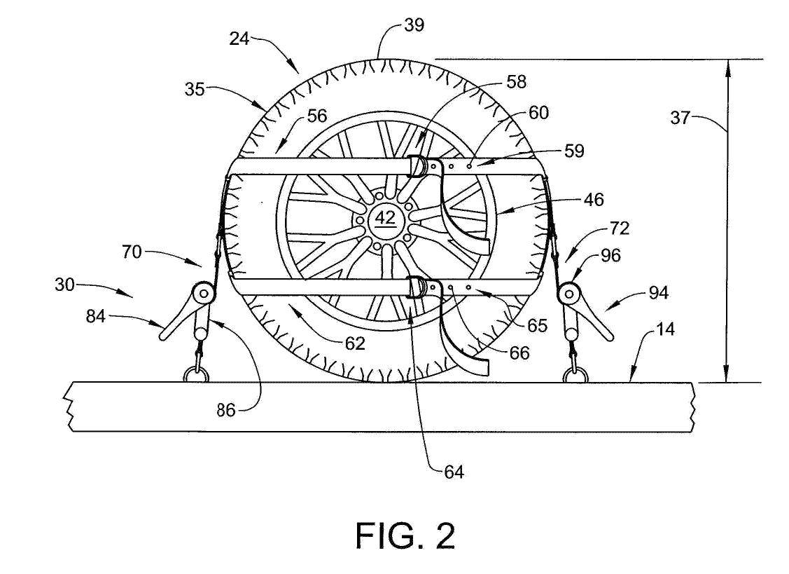

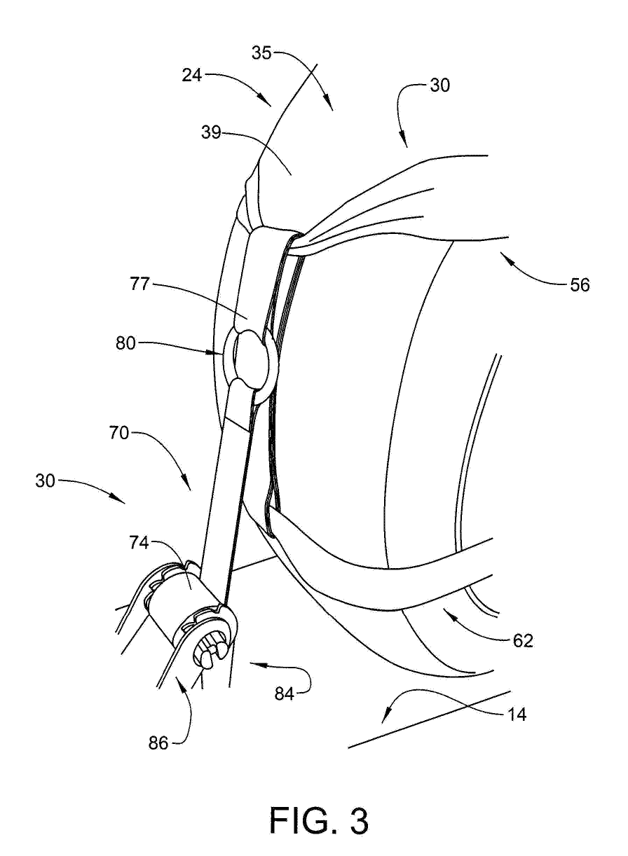

Reference will now follow to FIGS. 2 and 3 in describing first tie down system 30 with an understanding that second tie down system 32 includes similar structure. First vehicle wheel 24 includes a tire 35 defining an outer diameter 37 and an outer circumference 39. Vehicle wheel 24 includes a central axis 42. Outer diameter 37 passes through central axis 42. First vehicle wheel 24 also includes an inner portion 46 that extends about central axis 42 radially inwardly of outer diameter 37. In an embodiment, inner portion 46 may extend from central axis 42 out to tire 35.

In accordance with an exemplary embodiment, first tie down system 30 includes a first strap 56 that extends about first vehicle wheel 24 offset from outer diameter 37 in a first direction. First strap 56 intersects circumference 39 in at least two locations. First strap 56 includes a first adjustor mechanism 58 and may include a first plurality of discrete adjustment positions indicated generally at 59. First plurality of discrete adjustment positions 59 may take the form of a plurality of first openings 60 formed in first strap 56. First plurality of discrete adjustment positions 59 cooperate with first adjuster mechanism 58 to establish a selected length for first strap 56 that corresponds to, for example, a dimension of tire 35. In this manner, first adjustor mechanism 58 may take the form of a first buckle (not separately labeled) and may selectively adjust a length of first strap 56 by engaging with one of the plurality of first openings 60 to accommodate various wheel sizes.

First tie down system 30 also includes a second strap 62 that extends about first vehicle wheel 24 offset from outer diameter 37 in a second direction that is substantially opposite the first direction. Second strap 62 intersects circumference 39 in at least two locations. Second strap 62 includes a second adjustor mechanism 64 and may include a second plurality of discrete adjustment positions indicated generally at 65. First plurality of discrete adjustment positions 65 may take the form of a plurality of second openings 66 formed in second strap 62. Second plurality of discrete adjustment positions 65 cooperate with second adjuster mechanism 64 to establish a selected length for first strap 56 that corresponds to, for example, a dimension of tire 35. In this manner, second adjustor mechanism 64 may take the form of a second buckle (not separately labeled) and may selectively adjust a length of second strap 62 by engaging with one of the plurality of second openings 66 to accommodate various wheel sizes.

In further accordance with an exemplary embodiment, first tie down system 30 includes a first connector strap 70 and a second connector strap 72. First connector strap 70 includes a first strap portion 74 and a second strap portion 77 that may include a ring member 80. Second strap portion 77 may be looped through first and second straps 56 and 62. First strap portion 74 may be passed through ring member 80 and may then be connected to a first tensioner 84 which may take the form of a first ratcheting winch 86. Second connector strap 72 extends through first and second straps 56 and 62 on an opposing side of first vehicle wheel 24 and connects to a second tensioner 94 shown as a ratcheting winch 96.

In accordance with an exemplary embodiment, first and second connecting straps 70 and 72 are placed in tension to secure first vehicle wheel 24 to vehicle support surface 14. First and second connecting straps 70 and 72 act upon first and second straps 56 and 62 in a manner that avoid creating undesirable deformations in, for example, tire 35.

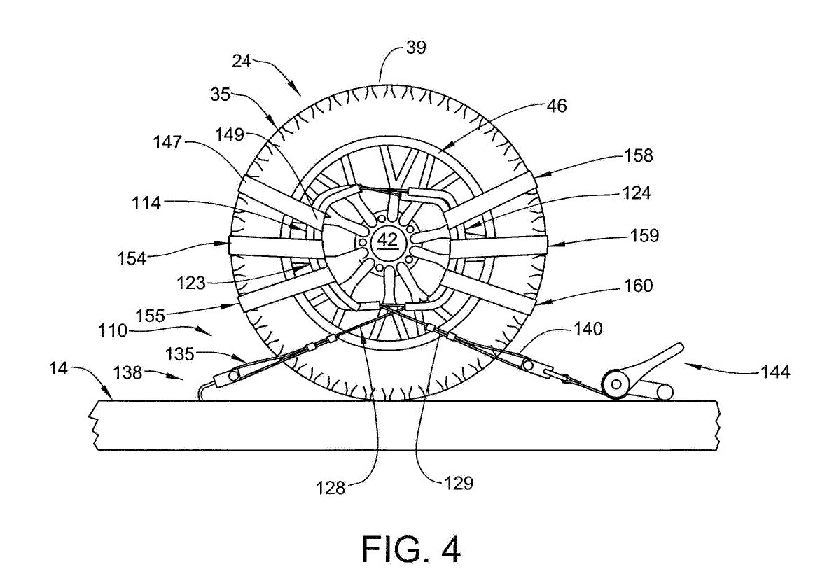

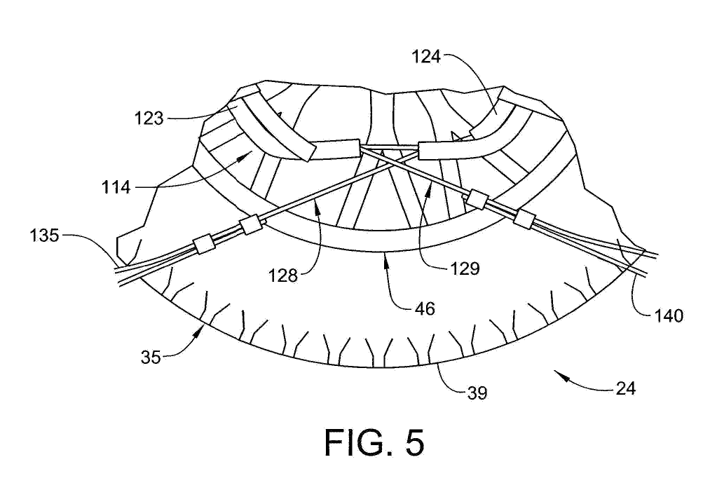

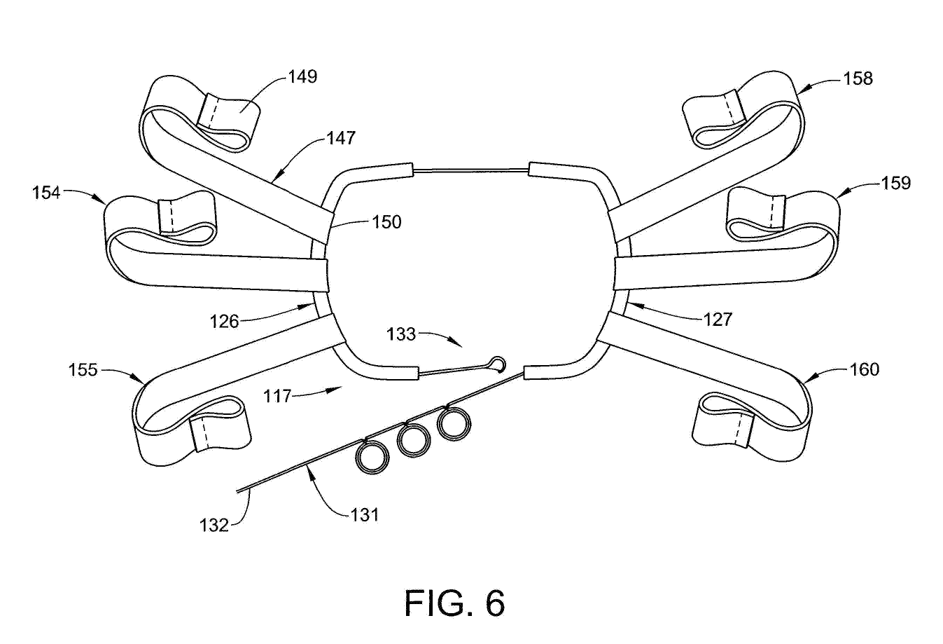

Reference will now follow to FIGS. 4-6, a tie down system 110 in accordance with another aspect of an exemplary embodiment. Tie down system 110 includes a first tensioning device 114 arranged about inner portion 46 on a first side (not separately labeled) of first vehicle wheel 24 and a second tensioning device 117 (FIG. 6) arranged about inner portion 46 on a second, opposing side (also not separately labeled) of first vehicle wheel 24. First tensioning device 114 includes a first tensioning member 123 and a second tensioning member 124. Similarly, second tensioning device 117 includes a first tensioning member 126 and a second tensioning member 127.

A first connector strap 128, shown in the form of a cable 129 extends through first and second tensioning members 123 and 124. A second connector strap 131, shown in the form of a second cable 132 extends through second tensioning device 117. Second cable 132 may include a connector feature 133. Connector feature 133 allows an operator to separate second cable 132 into two parts to accommodate suspension and/or drive components (not shown) arranged on the second side of first vehicle wheel 24. First connector strap 128 includes a first end 135 connected to a fixed anchor 138 on vehicle support surface 14 and a second end 140 that may be connected to a tensioner 144. Second connector strap 131 may be connected to vehicle support surface 14 in a similar manner.

A first strap 147 is connected to first and second tensioning devices 114 and 117. That is, a first end 149 of first strap 147 is connected to first tensioning device 114 and a second end 150 is connected to second tensioning device 117. In this manner, first strap 147 intersects circumference 39. In addition to first strap 147, a second strap 154 and a third strap 155 are connected to first and second tensioning devices 114 and 117 at a first end (not separately labeled) of first vehicle wheel 24. A fourth strap 158, a fifth strap 159 and a sixth strap 160 may also be connected to first and second tensioning devices 114 and 17 at a second end (also not separately labeled). Second, third, fourth, fifth, and sixth straps 154, 155, 158, 159, and 160 intersect circumference 39. After first, second, third, fourth, fifth, and sixth straps 147, 154, 155, 158, 159, and 160 are secured, tensioner 144 may be activated to contract first tensioning device 114 to secure first vehicle wheel 24 to vehicle support surface 14.

At this point, it should be understood that the exemplary embodiments describe a system for securing a vehicle to a transport that does not deform vehicle tires. Further, it should be understood that the exemplary embodiments may be employed on vehicles that employ both pneumatic and non-pneumatic tires. That is, the exemplary embodiments may be employed to secure a wide array of vehicles to a transport including passenger vehicles, trucks, vans, sport utility vehicles, MPV's cross-over vehicles, ATV's, tractors and the like.

The terms “about” and “substantially” are intended to include the degree of error associated with measurement of the particular quantity based upon the equipment available at the time of filing the application. For example, “about” and “substantially” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A method for securing a vehicle to a vehicle transport comprising:
placing a first strap about a portion of a vehicle wheel, the first strap extending across first and second axially outer surfaces of and intersecting a circumference of the vehicle wheel;
positioning a second strap about another portion of the vehicle wheel, the second strap extending across first and second axially outer surfaces of and intersecting a circumference of the vehicle wheel;
connecting the first strap to the second strap with a connecting strap; and
securing the connecting strap to the vehicle transport.

2. The method of claim 1, wherein securing the connecting strap to the vehicle transport includes placing the connecting strap in tension.

3. The method of claim 1, further comprising: connecting the first strap to the second strap with another connecting strap.

4. The method of claim 3, further comprising: securing the another connecting strap to the vehicle transport.

5. The method of claim 4, wherein securing the another connecting strap includes placing the another connecting strap in tension.

6. The method of claim 1, wherein placing the first strap about a portion of the vehicle wheel includes intersecting a circumference of the vehicle wheel at an outer diameter of the vehicle wheel twice.

7. The method of claim 6, wherein placing the first strap about a portion of the vehicle wheel includes placing the first strap about the vehicle wheel spaced from a central axis in a first direction and positioning the second strap about another portion of the vehicle wheel includes positioning the second strap about the vehicle wheel spaced from the central axis in a second direction.

8. The method of claim 1, wherein placing the first strap about the portion of the vehicle wheel includes connecting a first end of the first strap to a first tensioning device extending about an inner portion of a first side of the vehicle wheel and connecting a second end of the first strap about a second tensioning device extending about an inner portion of a second side of the vehicle wheel.

9. The method of claim 8, wherein connecting the first strap to the second strap with the connecting strap includes passing a cable about the inner portion of the first side of the vehicle wheel through the first and second tensioning devices.

10. The method of claim 9, wherein securing the connecting strap to the vehicle transport includes fixing a first end of the cable to the vehicle transport and connecting a second end of the cable to a tensioner.

11. The method of claim 1, wherein placing the first strap about the portion of the vehicle wheel includes setting a selected length of the first strap through one of a plurality of discrete adjustment positions.

12. The method of claim 11, wherein setting the selected length includes engaging a first adjustor mechanism with an opening formed in the first strap.

13. The method of claim 12, wherein positioning the second strap about the another portion of the vehicle wheel includes setting a selected length of the second strap through one of a second plurality of discrete adjustment positions.

14. The method of claim 13, wherein setting the selected length includes engaging a second adjustor mechanism with an opening formed in the second strap.

15. The method of claim 12, wherein positioning the second strap about the another portion of the vehicle wheel includes setting a selected length of the second strap through one of a second plurality of discrete adjustment positions.

16. The method of claim 15, wherein setting the selected length of the second strap through one of the second plurality of discrete adjustment positions includes engaging a second adjustor mechanism with an opening formed in the second strap.
